(19) United States
(12) Patent Application Publication
(10) Pub. No.: US 2008/0039969 A1
(43) Pub. Date: Feb. 14, 2008

(54) Control schema of molding-system process, amongst other things

(75) Inventors: Mingyu Liu, Bolton (CA); Yunus Mohamed, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/503,609

(22) Filed: Aug. 14, 2006

(51) Int. Cl. B29C 39/00

(52) U.S. Cl. 700/197; 700/40; 700/200

(57) ABSTRACT

Disclosed is: (i) a method of controlling a molding system, (ii) a molding system, (iii) a controller of a molding system, (iv) an article of manufacture of a controller of a molding system and/or (v) a network-transmittable signal of a controller of a molding system, amongst other things.

### TECHNICAL FIELD

The present invention generally relates to, but is not limited to, molding systems, and more specifically the present invention relates to, but is not limited to, (i) a method of controlling a molding system, (ii) a molding system, (iii) a controller of a molding system, (iv) an article of manufacture of a controller of a molding system and/or (v) a network-transmittable signal of a controller of a molding system, amongst other things.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

Control theory deals with the behavior of dynamical systems. The desired output of a system is called the reference. When one or more output variables of a system need to follow a certain reference over time, a controller manipulates the inputs to the system to obtain the desired effect on the output of the system. Consider an automobile's cruise control, which is a device designed to maintain a constant vehicle speed. The output variable of the system is vehicle speed. The input variable is the engine's torque output, which is regulated by the throttle. A simple way to implement cruise control is to lock the throttle position when the driver engages cruise control. However, on hilly terrain, the vehicle will slow down going uphill and accelerate going downhill. This type of controller is called an open-loop controller because there is no direct connection between the output of the system and its input. In a closed-loop control system, a feedback control monitors the vehicle's speed and adjusts the throttle as necessary to maintain the desired speed. This feedback compensates for disturbances to the system, such as changes in slope of the ground or wind speed.

To avoid the problems of the open-loop controller, control theory introduces feedback. A closed-loop controller uses feedback to control states or outputs of a dynamical system. Its name comes from the information path in the system: process inputs (e.g. voltage applied to a motor) have an effect on the process outputs (e.g. velocity or position of the motor), which is measured with sensors and processed by the controller; the result (the control signal) is used as input to the process, closing the loop. Closed-loop controllers have the following advantages over open-loop controllers: (i) disturbance rejection (such as unmeasured friction in a motor), (ii) guaranteed performance even with model uncertainties, when the model structure does not match perfectly the real process and the model parameters are not exact, (iii) unstable processes can be stabilized. To obtain good performance, closed-loop and open-loop are used simultaneously; open-loop improves set-point (the value desired for the output) tracking. The most popular closed-loop controller architecture, by far, is the PID controller.

Every control system must guarantee first the stability of the closed-loop behavior. For linear systems, this can be obtained by directly placing the poles. Non-linear control systems use specific theories (normally based on Lyapunov's Theory) to ensure stability without regard to the inner dynamics of the system. The possibility to fulfill different specifications varies from the model considered and the control strategy chosen. The so-called PID controller is probably the most-used feedback control design, being the simplest one. “PID” means Proportional-Integral-Derivative, referring to the three terms operating on the error signal to produce a control signal. If u(t) is the control signal sent to the system, y(t) is the measured output and r(t) is the desired output, and tracking error e(t)=r(t)-y(t), a PID controller has the general form:

u(t)=K_{P}e(t)+K_{I}∫e(t)dt+K_{D}ė(t)

The desired closed loop dynamics is obtained by adjusting the three parameters K_{P}, K_{I}, and K_{D}, often iteratively by “tuning” and without specific knowledge of a plant model. Stability can often be ensured using only the proportional term. The integral term permits the rejection of a step disturbance (often a striking specification in process control). The derivative term is used to provide damping or shaping of the response. PID controllers are the most well established class of control systems: however, they cannot be used in several more complicated cases, especially if MIMO (Multi-Input-Multi-Output) systems are considered.

PID controller (a proportional-integral-derivative controller) is a common feedback loop component in industrial control systems. The controller compares a measured value from a process (typically an industrial process) with a reference setpoint (that is, desired) value. The difference (or “error” signal) is then used to calculate a new value for a manipulatable input to the process that brings the process' measured value back to its desired setpoint. Unlike simpler control algorithms, the PID controller can adjust process outputs based on the history and rate of change of the error signal, which gives more accurate and stable control. (It can be shown mathematically that a PID loop will produce accurate, stable control in cases where a simple proportional control would either have a steady-state error or would cause the process to oscillate). PID controllers do not require advanced mathematics to design and can be easily adjusted (or “tuned”) to the desired application, unlike more complicated control algorithms based on optimal control theory.

The PID loop tries to automate what an intelligent operator with a gauge and a control knob would do. The operator would read a gauge showing the input measurement of a process, and use the knob to adjust the output of the process (the “action”) until the process's input measurement stabilizes at the desired value on the gauge. In older control literature this adjustment process is called a “reset” action. The position of the needle on the gauge is a “measurement”, “process value” or “process variable”. The desired value on the gauge is called a “setpoint.” The difference between the gauge's needle and the setpoint is the “error”.

A control loop consists of three parts: (i) measurement by a sensor connected to the process, (ii) decision in a controller element, (iii) action through an output device (“actuator”) such as a control valve. As the controller reads a sensor, it subtracts this measurement from the “setpoint” to determine the “error”. It then uses the error to calculate a correction to the process's output variable (the “action”) so that this correction will remove the error from the process's input measurement. In a PID loop, correction is calculated from the error in three ways: cancel out the current error directly (Proportional), the amount of time the error has continued uncorrected (Integral), and anticipate the future error from the rate of change of the error over time (Derivative).

For example: suppose a water tank is used to supply water for use in several parts of a plant, and it is necessary to keep the water level constant. A sensor would measure the height of water in the tank, producing the “measurement”, and continuously feed this data to the controller. The controller would have a “setpoint” of (for example) 75% full. The controller would have its output (the “action”) connected to a proportionally-controlled characterized control valve controlling the make-up water feed. Opening the valve would increase the rate of water entering the tank, closing the valve would decrease it. The controller would use the measurement of how the level is changing over time to calculate how to manipulate the control valve to maintain a constant level at the “setpoint”.

A PID controller can be used to control any measurable variable which can be affected by manipulating some other process variable. For example, it can be used to control temperature, pressure, flow rate, chemical composition, speed, or other variables. Automobile cruise control is an example of a process outside of industry which utilizes crude PID control. Some control systems arrange PID controllers in cascades or networks. That is, a “master” control produces signals used by “slave” controllers. One common situation is motor controls: one often wants the motor to have a controlled speed, with the “slave” controller (often built into a variable frequency drive) directly managing the speed based on a proportional input. This “slave” input is fed by the “master” controllers' output, which is controlling based upon a related variable. Coupled and cascaded controls are common in chemical process control, heating, ventilation, and air conditioning systems, and other systems where many parts cooperate.

The PID loop adds positive corrections, removing error from the process's controllable variable (its input). Differing terms are used in the process control industry: The “process variable” is also called the “process's input” or “controller's output.” The process's output is also called the “measurement” or “controller's input.” This “up a bit, down a bit” movement of the process's input variable is how the PID loop automatically finds the correct level of input for the process. Removing the error “turns the control knob,” adjusting the process's input to keep the processes measured output at the setpoint. The error is found by subtracting the measured quantity from the setpoint. “PID” is named after its three correcting calculations, which all add to and adjust the controlled quantity. These additions are actually “subtractions” of error, because the proportions are usually negative: (i) Proportional—To handle the present, the error is multiplied by a (negative) constant P (for “proportional”), and added to (subtracting error from) the controlled quantity. P is only valid in the band over which a controller's output is proportional to the error of the system. For example, for a heater, a controller with a proportional band of 10° C. and a setpoint of 20° C. would have an output of 100% at 10° C., 50% at 15° C. and 10% at 19° C. Note that when the error is zero, a proportional controller's output is zero. (ii) Integral—To handle the past, the error is integrated (added up) over a period of time, and then multiplied by a (negative) constant I (making an average), and added to (subtracting error from) the controlled quantity averages the measured error to find the process output's average error from the setpoint. A simple proportional system oscillates, moving back and forth around the setpoint, because there's nothing to remove the error when it overshoots. By adding a negative proportion of (i.e. subtracting part of) the average error from the process input, the average difference between the process output and the setpoint is always being reduced. Therefore, eventually, a well-tuned PID loop's process output will settle down at the setpoint. (iii) Derivative—To handle the future, the first derivative (the slope of the error) over time is calculated, and multiplied by another (negative) constant D, and also added to (subtracting error from) the controlled quantity. The derivative term controls the response to a change in the system. The larger the derivative term, the more rapidly the controller responds to changes in the process's output. Its D term is the reason a PID loop is also called a “Predictive Controller.” The D term is reduced when trying to dampen a controller's response to short term changes. Practical controllers for slow processes can even do without D. More technically, a PID loop can be characterized as a filter applied to a complex frequency-domain system. This is useful in order to calculate whether it will actually reach a stable value. If the values are chosen incorrectly, the controlled process input can oscillate, and the process output may never stay at the setpoint.

U.S. Pat. No. 4,272,466 (Inventor: Harris; Published: Jun. 6, 1981) discloses a system and method of temperature control for a plastics extruder that uses a deep well sensor and a shallow well sensor in each temperature control zone along an extruder barrel. The temperature indications of these sensors are not combined. The shallow sensor detects temperature near the barrel surface. An associated controller compares the sensor temperature with a manually preset temperature set point. The differences between the detected and set temperature are used by the controller to effect heating or cooling of its associated temperature control zone. Each deep sensor is located proximate the bore in which the plastic is moved. The deep sensor temperature indication is compared with the set point of a second controller. Variations of the deep temperature from the set point generate an error signal that is applied to the first, shallow well temperature controller to vary its set point. A melt temperature control addition can be made by adding a melt temperature sensor directly in the path of melt between the extruder screw and the extrusion die. A further controller compares its set point with that of the melt temperature and modifies the deep temperature controller set points of the several zones along the extruder barrel to correct the melt temperature.

U.S. Pat. No. 4,309,114 (Inventor: Klien et al; Published: Jan. 5, 1982) discloses an apparatus and a method in which the temperature of the barrel inner surface and the temperature of the screw conveyor outer surface of a plasticating extruder are varied, alternately, in repeated steps, independent of one another along at least a portion of the solids conveying zone of the extruder, while a production effectiveness parameter simultaneously is monitored, until the monitored production effectiveness parameter is optimized and the production effectiveness of the extruder is at a desired maximum.

U.S. Pat. No. 4,843,576 (Inventor: Smith et al; Published: Jun. 27, 1989) discloses an arrangement for controlling the process temperature in an industrial process that involves an extruding operation includes a summing element which sums the difference between the process temperature and a setpoint temperature with the rate of change of the process temperature and conveys this sum to a proportional and integral controller so that the output thereof acts in an inverse manner with the process temperature. This output of the controller is summed with the change of temperature rate which has been fed forward, to generate a demand signal. The demand signal is shaped and compared to a ramp waveform to generate a variable frequency pulse for controlling a heating and/or cooling device associated with the extruding device. A change of speed rate can also be summed to form the demand signal.

U.S. Pat. No. 5,149,193 (Inventor: Faillace; Published: September 1992) discloses an extruder temperature controller for an extruder barrel and a method for controlling the temperature of an extruder barrel. The controller includes a device for determining an actual screw speed and for storing a plurality of screw speeds. Each member of the plurality of stored screw speeds has a corresponding stored temperature reset value. The extruder temperature controller has a device for comparing and selecting that compares the actual screw speed to each of the plurality of stored screw speeds and selects a default screw speed. The default screw speed has a smaller deviation from the actual screw speed than any other member of the compared, stored screw speeds. The controller further includes a device for generating a control output driver signal to a heat exchanger. The control output driver signal is the corresponding stored temperature reset value for the default screw speed. The adaptive reset value for a specific speed is derived for each extruder barrel zone for each profile table section of setpoints and parameters for a particular extrusion material and particular process.

U.S. Pat. No. 5,397,515 (Inventor: Searle et al; Published: Mar. 14, 1995) discloses a control system for controlling the temperature within process machinery such as the feed assembly in an injection molding machine. The control system provides a six phase process for starting up the machine from cold conditions and controlling the machine temperature to rapidly and accurately attain a command temperature while identifying control parameters for use under steady state conditions for maintaining the command temperature.

U.S. Pat. No. 5,456,870 (Inventor: Bulgrin; Published: Oct. 10, 1995) discloses an improved temperature control system that uses a state controller with two degrees of freedom to regulate the temperature of the barrel of an injection molding machine is disclosed. The control system divides the temperature of the barrel into longitudinally-extending zones and radially extending layers within each zone. Heat transfer calculations which include the effects of heat transfer between all the layers within the zones are performed for a set time in the future to accurately determine the heat needed from the heater band to reach the operator set point temperature. The duty cycle for the heater bands is thus accurately set to give a more responsive and accurate control than heretofore possible. The controller additionally includes factors for accounting for heat disturbances present in the injection molding process. In addition each system is calibrated for each machine to insure accurate formulation of machine specific parameters such as heat transfer coefficients used in the control.

U.S. Pat. No. 6,529,796 (Inventor: Kroeger et al; Published: Mar. 4, 2003) discloses an injection mold apparatus that has multiple injection zones, each zone having at least one heater and at least one temperature sensor generating a temperature indicating signal. A power source provides power to the heaters. A controller controls the temperature of at least some of the zones. For efficiency, the controller has two separate processors, a data-receiving processor for receiving temperature indicating signal from each sensor as well as power signals, and a control processor for receiving data from the data-receiving processor and for controlling the amount of power provided to the heaters. Preferably, the control is located in housing, with the housing mounted directly on the mold. Modified PID calculations are utilized. Power calculations for the amount of power to the heaters utilizes a modulo based algorithm.

U.S. Pat. No. 6,861,018 (Inventor: Koyama; Published: Mar. 1, 2005) discloses heat-up characteristics that are obtained individually for a plurality of heat zones of an injection molding machine. A heat-up time is obtained from the heat-up characteristic of each heat zone and the difference between a preset temperature and an actual temperature. A heat zone that requires the longest heat-up time is specified. Heat-up of each heat zone is controlled in accordance with the longest heat-up time.

United States Patent Application Number 2006/0082009 (Inventor: Saggese et al; Published: Apr. 20, 2006) discloses an intelligent molding system that makes use of data directly associated with a molding environment or particular mold. Accessible data, typically stored locally in an in-mold memory device or input via a human-machine interface (HMI), identifies parameters germane to mold set-up and machine operation. Upon receiving such data, a machine controller operates to configure a molding machine to an initial set-up defined by the data considered close to an optimal operating condition for the mold. Mold set-up data can include information relating to a fill profile for a molded article that is partitioned into different zones having different thicknesses and geometries. Weighting factors for the various zones compensate for differing cooling and flow characteristics. The memory can also be used to store historical data pertaining to mold operation, settings and alarms.

United States Patent Number 2006/0082010 (Inventor: Saggese et al; Published: Apr. 20, 2006) discloses a closed loop control of the clamp pressure (such as through control of hydraulic pistons) permits clamp pressure to balance exactly, but preferably slightly exceed, the instantaneous injection pressure (rather than developing full closure tonnage for a substantial portion of the duration of an injection cycle). A first approach mimics the injection pressure profile with time, whereby applied tonnage is varied with time according to sensed pressure measurements. A second approach looks to pre-stored or historically accumulated injection pressure information and, instead of varying the tonnage, applies a constant tonnage reflecting the maximum recorded or most likely injection pressure to be experienced in the mold (as recorded stored in a look-up table associated with the particular mold configuration). A machine controller causes the application of applied tonnage through the platen and tie-bars of an injection molding machine. Pressure sensors located either on a mold surface, relative to stack components and/or relative to a force closure path of permit a microprocessor to control applied clamp closure tonnage. In this way, the system consumes less power and component wear is reduced.

### SUMMARY

According to a first aspect of the present invention, there is provided a method of controlling a molding system, the method including selecting a control schema from amongst several control schemas usable for controlling a process of the molding system.

According to a second aspect of the present invention, there is provided a molding system, having molding-system components, and also having a controller interfaced with at least one molding-system component, the controller including a controller-usable medium embodying instructions being executable by the controller, the instructions, including executable instructions for directing the controller to select a control schema from amongst several control schemas usable for controlling a process of the molding system.

According to a third aspect of the present invention, there is provided, for a molding system having molding-system components, a controller interfacable with at least one molding-system component, the controller having a controller-usable medium embodying instructions being executable by the controller, the instructions including executable instructions for directing the controller to select a control schema from amongst several control schemas usable for controlling a process of the molding system.

According to a fourth aspect of the present invention, there is provided, for a controller of a molding system having molding-system components, the controller interfacable with at least one molding-system component, an article of manufacture, having a controller-usable medium embodying instructions executable by the controller, the instructions, including executable instructions for directing the controller to select a control schema from amongst several control schemas usable for controlling a process of the molding system.

According to a fifth aspect of the present invention, there is provided, for a controller of a molding system having molding-system components, the controller interfacable with at least one molding-system component, a network-transmittable signal, having a carrier signal modulatable to carry instructions executable by the controller, the instructions including executable instructions for directing the controller to select a control schema from amongst several control schemas usable for controlling a process of the molding system.

Technical effect, amongst other technical effects, of the aspects of the present invention is improved control of a process of a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a molding system according to an exemplary embodiment (variants of the exemplary embodiment, and other embodiments will be described);

FIG. 2 is a schematic representation of a feedback loop control schema 170 of the molding system of FIG. 1; and

FIG. 3 is a schematic representation of an operation of instructions to be executed by a controller of the molding system of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

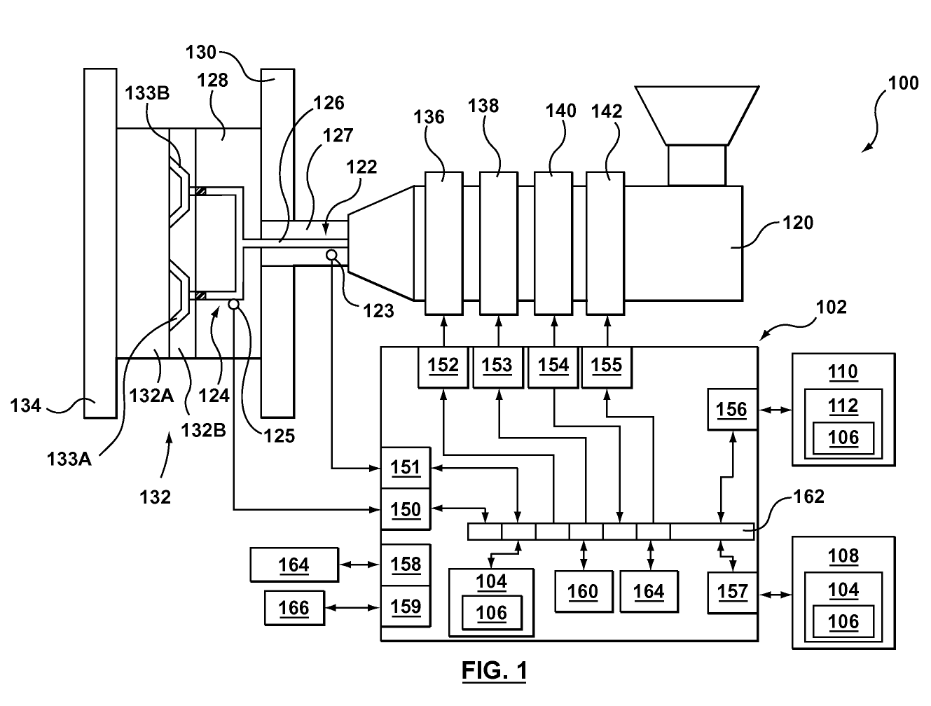

FIG. 1 is a schematic representation of a molding system 100 (hereafter referred to as the “system 100”) according to the exemplary embodiment. The system 100 is operatively couplable to a controller 102 via wireless communications, hardwiring, etc, used for transmitting control information and/or data information between the system 100 and the controller 102. The controller 102 is used to control the system 100 (that is, to direct the system 100) according to a method that includes selecting a control schema from amongst several control schemas usable for controlling a process of the system 100. A control schema (or control scheme) is a method (algorithm or instructions of a controller) used to accomplish control (automatic, semi-automatic and/or manual) of the system 100. Preferably, the method includes selecting, in real-time, the control schema from amongst several control schemas usable for controlling a process of the system 100. Real-time relates to (i) computer systems that update information at the same rate as they receive data, enabling them to direct or control a process such as an automatic pilot, (ii) the actual time during which a computing event occurs; that is, current as opposed to delayed and/or (iii) computer systems that update information at the same rate they receive information.

For example, the molding system 100 is operating in automatic control mode (under the directions of a controller or equivalent). When a random change in a process of the system 100 occurs, the controller is to continue automatic control of the process in a slow approach so as to not upset the process too much. However, when the controller senses or detects an operator request to change the process, the controller then selects another control schema (from amongst several—that is the control schema the controller is currently executing or another control schema that the controller can begin using in order to quickly respond to the request of the operator of the system 100).

Preferably, the system 100 includes an extruder 120 (such as an injection unit with either single screw feed or twin screw feed). Thermal condition of zones 122, 124 (any one zone or both zones) are measured by way of thermal sensors 123, 125 respectively that are placed proximate of the zones 122, 124. The sensors 123, 125 are operatively coupled to the controller 102. By way of example, the process is control of heaters 136, 138, 140, 142 that are coupled to the extruder 120; the heaters 136, 138, 140, 142 are used for applying heat to molding material held in the extruder 120. The molding system 100 also includes a melt passageway 126 formed by any one of: (i) a machine nozzle 127, (ii) a sprue, (iii) a manifold of a hot runner 128 and (iv) any combination and permutation thereof.

The machine nozzle 127 connects the extruder 120 to the hot runner 128. According to a variant (not depicted), the hot runner 128 is not used. The hot runner 128 is attached to a stationary platen 130. The machine nozzle 127 passes through the stationary platen 130. A mold 132 includes (i) a stationary mold portion 132B that is attached to the hot runner 128 and (ii) a movable mold portion 132A that is attached to a movable platen 134. The mold 132 defines mold cavities 133A, 133B.

Preferably, the molding system 100 also includes (i) a clamping mechanism (not depicted) used to generate a clamping force, (ii) a mold-break force applicator (not depicted) used to generate a mold break force and (iii) tie bars (not depicted) that couple the clamping mechanism and the mold-break mechanism to the mold 132 and the tie bars are used to transfer the clamping force and the mold-break force from the clamping mechanism and from the mold-break applicator, respectively, to the mold 132. Since the structure and operation of the clamping mechanism and the mold-break applicator are known to persons skilled in the art of molding systems, these mechanisms will not be described in detail and will not be illustrated.

Extruder heaters 136, 138, 140, 142 are coupled to the extruder 120. Preferably, the extruder 120 includes a reciprocating screw (not depicted) that is used to (i) process or convert chips (or larger portions) of magnesium (or other types of metal, such as aluminum, zinc, etc) or (ii) process plastic material (such as PET—polyethylene terephthalate, thermoplastic resin, etc). The extruder heaters 136, 138, 140, 142 are used to keep the molten metallic molding material hot before it is injected into the mold cavities 133A, 133B defined by the mold 132. The melt passageway 126 extends from the extruder 120 through the machine nozzle 127 and through the hot runner 128 and leading up to the gate (the gate is the entrance to the cavities defined by the mold 132). The controller 102 is used to control or change the thermal condition (a process) of an extruder 120 by controlling the extruder heaters 136, 138, 140, 142 (that is, turning the extruder heaters 136 to 142 on or off in combination or individually according to programmed instructions that are used to direct the controller 102 to control the extruder heaters 136 to 142).

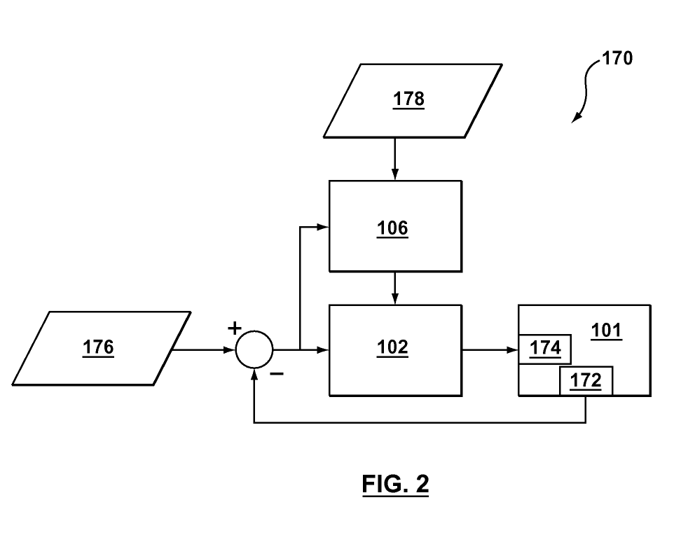

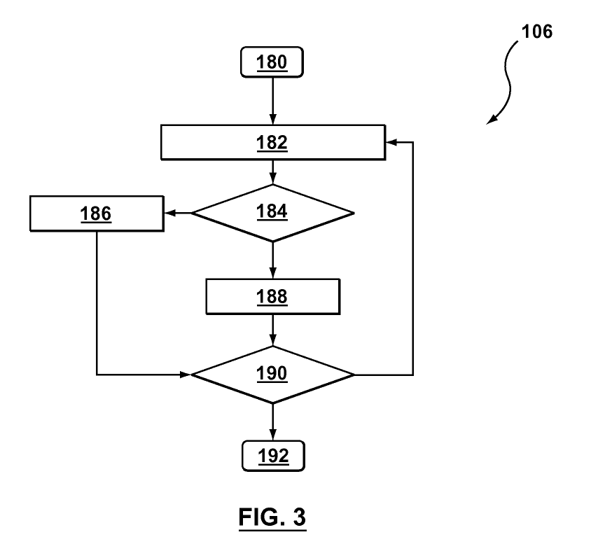

The controller 102 is programmable and includes a controller-usable medium 104 (such as a hard disk, floppy disk, compact disk, optical disk, flash memory, random-access memory, etc) that embodies programmed instructions 106 (hereafter referred to as the “instructions 106”). The instructions 106 are executable by the controller 102. The instructions 106 include executable instructions for directing the controller 102 to select a control schema from amongst several control schemas usable for controlling a process of the system 100. Operation of the controller 102 is described below in connection with FIGS. 2 and 3.

The instructions 106 may be delivered to the controller 102 via several approaches. An article of manufacture 108 may be used to deliver the instructions 106 to the controller 102. The article of manufacture 108 includes a controller-usable medium 104 (such as a hard disk, floppy disk, compact disk, optical disk, flash memory, etc) that is enclosed in a housing unit. The controller-usable medium 104 embodies the instructions 106. The article of manufacture 108 is interfacable with the controller 102 (such as via a floppy disk drive reader, etc). A network-transmittable signal 110 may also be used (separately or in conjunction with the article of manufacture 108) to deliver the instructions 106 to the controller 102. The network-transmittable signal 110 includes a carrier signal 112 modulatable to carry the instructions 106. The network-transmittable signal 110 is transmitted via a network (such as the Internet) and the network is interfacable with the controller 102 (such as via a modem, etc).

The controller 102 includes interface modules 150 to 159 (all known to persons skilled in the art) inclusive that are used to interface the controller 102 to: (i) the thermal sensors 125, 123, (ii) the extruder heaters 136 to 142 inclusive, (iii) the network-transmittable signal 110 and (iv) the article of manufacture 108 respectively, amongst other things. The interface modules 150, 151 are temperature-sensor interface modules. The interface modules 152 to 155 are heater-interface modules. The interface module 156 is a modem. The interface module 157 is a controller-usable medium reader (such as a floppy disk, etc).

Preferably, a display 164 (such as a flat panel screen, etc) is used as a human-machine interface; the display 164 is interfaced to the controller 102 via an interface module 158 that connects the display 164 to a bus 162. A keyboard and/or mouse 166 (that is, operator control equipment) are interfaced to the controller 102 via an interface module 159 that connects the keyboard and/or mouse 166 to the bus 162 (as known to those skilled in the art).

The controller 102 also includes a CPU (Central Processing Unit) 160 that is used to execute the instructions 106. The bus 162 is used to interface the interface modules 150 to 157, the CPU 160 and the controller-usable medium 104. The controller-usable medium 104 also includes an operating system (such as the Linux operating system) that is used to coordinate automated processing functions related to maintaining the controller 102 in operational condition. A database (not depicted) is coupled to the bus 162 so that the CPU 160 may keep data records pertaining to the operational parameters of the system 100.

FIG. 2 is a schematic representation of a feedback loop control schema 170 (hereafter referred to as the “schema 170” or “control schema 170”) of the system 100 of FIG. 1. The schema 170 is implemented using the controller 102 of FIG. 1. The controller 102 is preferably a PID controller that uses control parameters K_{P}, K_{I}, and K_{D}. A process 101 of the system 100 generates an output 172 that is then measured and then compared against a reference setpoint 176. A difference (or error) is generated by the controller 102. The difference is between the setpoint 176 and the measured output 172 of the process 101. The instructions 106 instruct the controller 102 to compare the difference against a threshold 178. Based on the comparison made between the difference and the threshold 178, the instructions 106 direct the controller 102 to select a control schema from several control schemas. The control schemas may be a set of predetermined control schemas, for example. Then, the instructions 106 direct the controller 102 to use the selected control schema. The controller 102 responds by generating a new valve of a manipulatable input 174 for the process 101 (for controlling the output 172). The manipulatable input is transmitted or is feed to the input 174 of the process 101.

FIG. 3 is a schematic representation of an operation of the instructions 106 that are to be executed by the controller 102 of the system 100 of FIG. 1. The instructions 106 are coded in programmed statements that are written in a controller-programming language, such as (i) a high-level progamming language (C++, Java, etc) which is then translated into machine level code or (ii) assembly language/machine code, etc. The instructions 106 are compiled and linked, etc (as known to those skilled in the art) in order to make the instructions 106 executable by the controller 102.

Operation 180 includes starting of the instructions 106; control is then transferred to operation 182. Operation 182 includes directing the controller 102 to determine a difference between a setpoint 176 of the process 101 of the system 100 and a measured output 172 of the process 101. Operation 184 includes directing the controller 102 to determine whether the determined difference is greater than the threshold 178. If the determined difference is greater than the threshold 178, control is then transferred to operation 186. If the determined difference is less than (or equal to) the threshold 178, control is then transferred to operation 188.

Operation 186 includes directing the controller 102 to select a first control schema and then to use the selected first control schema that is then in turn used to generate a value of a manipulatable input of the process 101.

Operation 188 includes directing the controller 102 to select a second control schema and then to use the selected second control schema to generate a value of a manipulatable input of the process 101.

Preferably, the first control schema urges the process 101 to respond quickly (aggressively), and the second control schema urges the process 101 to respond slowly. The first control schema is enabled or used (in favor of using the second control schema) because it is likely that an operator of the system 100 has imposed a change to the process 101, and it would be prudent to have the system 100 respond to such a change request quickly (or fast); however, the second control schema is enabled or used (in favor of using then first control schema) because it is likely that the system 100 has imposed a random change to the process 101, and it would be prudent to have the system 100 respond to such a random change slowly (so that the process 101 may settle down without disrupting the overall performance of the system 100.

The instructions 106 may also include other executable instructions, such as: (i) selecting the control schema from amongst several control schemas based on a reading of a measurement of a sensor 123, 125 that are associated with the process 101 of the system 100, (ii) selecting the control schema from amongst several control schemas is based on a comparison between a measurement of a sensor 123, 12 and a value of the setpoint of the process 101, (iii) determining the comparison between the measurement of the sensor 123, 125 and the value of setpoint of the process parameter includes: comparing a threshold against the comparison between the measurement of the sensor 123, 125 and the value of setpoint of the process parameter, (iv) determining the comparison between the measurement of the sensor 123, 125 and the value of setpoint of the process parameter includes: comparing a threshold against the measurement, (v) determining a degree of change to be imposed to the process 101 in which the degree of change is based on the determined comparison made between the process measurement and a threshold, (vi) reading the value of the setpoint of the process 101 of the system 100, (vii) reading the measurement of the sensor 123, 125, (viii) controlling the process 101 of the system 100 using the selected control schema, and/or (ix) selecting the control schema usable for imposing any one of a quicker degree of change to the process 101 and a slower degree of change to the process 101.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. A method of controlling a molding system, the method comprising:
selecting a control schema from amongst several control schemas usable for controlling a process of the molding system.

2. The method of claim 1, further comprising:
selecting the control schema from amongst several control schemas based on a reading of a measurement of a sensor, the sensor associated with a process of the molding system.

3. The method of claim 1, further comprising:
selecting the control schema from amongst several control schemas based on a comparison between a measurement of a sensor, the sensor associated with a process of the molding system, and a value of a setpoint of the process of the molding system.

4. The method of claim 1, further comprising:
determining the comparison between the measurement of a sensor from a value of setpoint of the process parameter includes comparing a threshold against the comparison between the measurement of the sensor and the value of setpoint of the process parameter.

5. The method of claim 1, further comprising:
determining the comparison between the measurement of a sensor from a value of setpoint of the process parameter includes comparing a threshold against the measurement of the sensor.

6. The method of claim 1, further comprising:
determining a degree of change to be imposed to the process, the degree of change based on the determined comparison made between the process measurement and a threshold.

7. The method of claim 1, further comprising:
reading a value of the setpoint of the process of the molding system; and
reading the measurement of a sensor.

8. The method of claim 1, further comprising:
controlling the process of the molding system using the selected control schema.

9. The method of claim 1, further comprising:
selecting a control schema, the control schema usable for imposing any one of (i) a quicker degree of change to the process and (ii) a slower degree of change to the process.

10. A method of claim 1, further comprising:
measuring an output of a process of the molding system;
comparing the output against a setpoint;
generating a difference between the setpoint and the measured output of the process,
comparing a threshold against the difference between the setpoint and the measured output;
selecting the control schema from the several control schemas based on the comparison made between the threshold and the difference between the setpoint and the measured output;
generating a new valve of a manipulatable input of the process based on the selected control schema; and
transmitting the new value to the input of the process.

11. A molding system, comprising:
molding-system components; and
a controller interfaced with at least one molding-system component, the controller including:
a controller-usable medium embodying instructions being executable by the controller, the instructions, including:
executable instructions for directing the controller to select a control schema from amongst several control schemas usable for controlling a process of the molding system.

12. The molding system of claim 11, further comprising:
executable instructions for directing the controller to select the control schema from amongst several control schemas based on a reading of a measurement of a sensor, the sensor associated with a process of the molding system.

13. The molding system of claim 11, further comprising:
executable instructions for directing the controller to select the control schema from amongst several control schemas based on a comparison between a measurement of a sensor, the sensor associated with a process of the molding system, and a value of a setpoint of the process of the molding system.

14. The molding system of claim 11, further comprising:
executable instructions for directing the controller to determine the comparison between the measurement of a sensor from a value of setpoint of the process parameter includes comparing a threshold against the comparison between the measurement of the sensor and the value of setpoint of the process parameter.

15. The molding system of claim 11, further comprising:
executable instructions for directing the controller to determine the comparison between the measurement of a sensor from a value of setpoint of the process parameter includes comparing a threshold against the measurement of the sensor.

16. The molding system of claim 11, further comprising:
executable instructions for directing the controller to determine a degree of change to be imposed to the process, the degree of change based on the determined comparison made between the process measurement and a threshold.

17. The molding system of claim 11, further comprising:
executable instructions for directing the controller to read a value of the setpoint of the process of the molding system; and
reading the measurement of a sensor.

18. The molding system of claim 11, further comprising:
executable instructions for directing the controller to control the process of the molding system using the selected control schema.

19. The molding system of claim 11, further comprising:
executable instructions for directing the controller to select a control schema, the control schema usable for imposing any one of (i) a quicker degree of change to the process and (ii) a slower degree of change to the process.

20. A molding system of claim 11, further comprising:
executable instructions for directing the controller to measure an output of a process of the molding system;
executable instructions for directing the controller to compare the output against a setpoint;
executable instructions for directing the controller to generate a difference between the setpoint and the measured output of the process,
executable instructions for directing the controller to compare a threshold against the difference between the setpoint and the measured output;
executable instructions for directing the controller to select the control schema from the several control schemas based on the comparison made between the threshold and the difference between the setpoint and the measured output;
executable instructions for directing the controller to generate a new valve of a maniplulatable input of the process based on the selected control schema; and
executable instructions for directing the controller to transmit the new value to the input of the process.

21. For a molding system having molding-system components, a controller interfacable with at least one molding-system component, the controller comprising:
a controller-usable medium embodying instructions executable by the controller, the instructions including:
executable instructions for directing the controller to select a control schema from amongst several control schemas usable for controlling a process of the molding system.

22. The controller of claim 21, further comprising:
executable instructions for directing the controller to select the control schema from amongst several control schemas based on a reading of a measurement of a sensor, the sensor associated with a process of the molding system.

23. The controller of claim 21, further comprising:
executable instructions for directing the controller to select the control schema from amongst several control schemas based on a comparison between a measurement of a sensor, the sensor associated with a process of the molding system, and a value of a setpoint of the process of the molding system.

24. The controller of claim 21, further comprising:
executable instructions for directing the controller to determine the comparison between the measurement of a sensor from a value of setpoint of the process parameter includes comparing a threshold against the comparison between the measurement of the sensor and the value of setpoint of the process parameter.

25. The controller of claim 21, further comprising:
executable instructions for directing the controller to determine the comparison between the measurement of a sensor from a value of setpoint of the process parameter includes comparing a threshold against the measurement of the sensor.

26. The controller of claim 21, further comprising:
executable instructions for directing the controller to determine a degree of change to be imposed to the process, the degree of change based on the determined comparison made between the process measurement and a threshold.

27. The controller of claim 21, further comprising:
executable instructions for directing the controller to read a value of the setpoint of the process of the molding system; and
reading the measurement of a sensor.

28. The controller of claim 21, further comprising:
executable instructions for directing the controller to control the process of the molding system using the selected control schema.

29. The controller of claim 21, further comprising:
executable instructions for directing the controller to select a control schema, the control schema usable for imposing any one of (i) a quicker degree of change to the process and (ii) a slower degree of change to the process.

30. A controller of claim 21, further comprising:
executable instructions for directing the controller to measure an output of a process of the molding system;
executable instructions for directing the controller to compare the output against a setpoint;
executable instructions for directing the controller to generate a difference between the setpoint and the measured output of the process,
executable instructions for directing the controller to compare a threshold against the difference between the setpoint and the measured output;
executable instructions for directing the controller to select the control schema from the several control schemas based on the comparison made between the threshold and the difference between the setpoint and the measured output;
executable instructions for directing the controller to generate a new valve of a maniplulatable input of the process based on the selected control schema; and
executable instructions for directing the controller to transmit the new value to the input of the process.

31. For a controller of a molding system having molding-system components, the controller interfacable with at least one molding-system component, an article of manufacture, comprising:
a controller-usable medium embodying instructions executable by the controller, the instructions, including:
executable instructions for directing the controller to select a control schema from amongst several control schemas usable for controlling a process of the molding system.

32. The article of manufacture of claim 31, further comprising:
executable instructions for directing the controller to select the control schema from amongst several control schemas based on a reading of a measurement of a sensor, the sensor associated with a process of the molding system.

33. The article of manufacture of claim 31, further comprising:
executable instructions for directing the controller to select the control schema from amongst several control schemas based on a comparison between a measurement of a sensor, the sensor associated with a process of the molding system, and a value of a setpoint of the process of the molding system.

34. The article of manufacture of claim 31, further comprising:
executable instructions for directing the controller to determine the comparison between the measurement of a sensor and the value of setpoint of the process parameter includes comparing a threshold against the comparison between the measurement of the sensor and the value of setpoint of the process parameter.

35. The article of manufacture of claim 31, further comprising:
executable instructions for directing the controller to determine the comparison between the measurement of a sensor from a value of setpoint of the process parameter includes comparing a threshold against the measurement of the sensor.

36. The article of manufacture of claim 31, further comprising:
executable instructions for directing the controller to determine a degree of change to be imposed to the process, the degree of change based on the determined comparison made between the process measurement and a threshold.

37. The article of manufacture of claim 31, further comprising:
executable instructions for directing the controller to read a value of the setpoint of the process of the molding system; and
reading the measurement of a sensor.

38. The article of manufacture of claim 31, further comprising:
executable instructions for directing the controller to control the process of the molding system using the selected control schema.

39. The article of manufacture of claim 31, further comprising:
executable instructions for directing the controller to select a control schema, the control schema usable for imposing any one of (i) a quicker degree of change to the process and (ii) a slower degree of change to the process.

40. An article of manufacture of claim 31, further comprising:
executable instructions for directing the controller to measure an output of a process of the molding system;
executable instructions for directing the controller to compare the output against a setpoint;
executable instructions for directing the controller to generate a difference between the setpoint and the measured output of the process,
executable instructions for directing the controller to compare a threshold against the difference between the setpoint and the measured output;
executable instructions for directing the controller to select the control schema from the several control schemas based on the comparison made between the threshold and the difference between the setpoint and the measured output;
executable instructions for directing the controller to generate a new valve of a maniplulatable input of the process based on the selected control schema; and
executable instructions for directing the controller to transmit the new value to the input of the process.

41. For a controller of a molding system having molding-system components, the controller interfacable with at least one molding-system component, a network-transmittable signal), comprising:
a carrier signal modulatable to carry instructions executable by the controller, the instructions including:
executable instructions for directing the controller to select a control schema from amongst several control schemas usable for controlling a process of the molding system.

42. The network-transmittable signal of claim 41, further comprising:
executable instructions for directing the controller to select the control schema from amongst several control schemas based on a reading of a measurement of a sensor, the sensor associated with a process of the molding system.

43. The network-transmittable signal of claim 41, further comprising:
executable instructions for directing the controller to select the control schema from amongst several control schemas based on a comparison between a measurement of a sensor, the sensor associated with a process of the molding system, and a value of a setpoint of the process of the molding system.

44. The network-transmittable signal of claim 41, further comprising:
executable instructions for directing the controller to determine the comparison between the measurement of a sensor and the value of setpoint of the process parameter includes comparing a threshold against the comparison between the measurement of the sensor and the value of setpoint of the process parameter.

45. The network-transmittable signal of claim 41, further comprising:
executable instructions for directing the controller to determine the comparison between the measurement of a sensor from a value of setpoint of the process parameter includes comparing a threshold against the measurement of the sensor.

46. The network-transmittable signal of claim 41, further comprising:
executable instructions for directing the controller to determine a degree of change to be imposed to the process, the degree of change based on the determined comparison made between the process measurement and a threshold.

47. The network-transmittable signal of claim 41, further comprising:
executable instructions for directing the controller to read a value of the setpoint of the process of the molding system; and
reading the measurement of a sensor.

48. The network-transmittable signal of claim 41, further comprising:
executable instructions for directing the controller to control the process of the molding system using the selected control schema.

49. The network-transmittable signal of claim 41, further comprising:
executable instructions for directing the controller to select a control schema, the control schema usable for imposing any one of (i) a quicker degree of change to the process and (ii) a slower degree of change to the process.

50. A network-transmittable signal of claim 41, further comprising:
executable instructions for directing the controller to measure an output of a process of the molding system;
executable instructions for directing the controller to compare the output against a setpoint;
executable instructions for directing the controller to generate a difference between the setpoint and the measured output of the process,
executable instructions for directing the controller to compare a threshold against the difference between the setpoint and the measured output;
executable instructions for directing the controller to select the control schema from the several control schemas based on the comparison made between the threshold and the difference between the setpoint and the measured output;
executable instructions for directing the controller to generate a new valve of a maniplulatable input of the process based on the selected control schema; and
executable instructions for directing the controller to transmit the new value to the input of the process.
